(19) United States
(12) Patent Application Publication
(10) Pub. No.: US 2015/0261683 A1
(43) Pub. Date: Sep. 17, 2015

(54) CACHE MEMORY CONTROL IN ELECTRONIC DEVICE

(71) Applicant: Samsung Electronics Co., Ltd., Gyeonggi-do (KR)

(72) Inventors: Eunseok HONG, Gyeonggi-do (KR); Byoungik KANG, Seoul (KR); Gilyoon KIM, Gyeonggi-do (KR); Jinyoung PARK, Gyeonggi-do (KR); Seungjin YANG, Gyeonggi-do (KR); Jinyong JANG, Gyeonggi-do (KR); Chunmok CHUNG, Gyeonggi-do (KR); Jin CHOI, Gyeonggi-do (KR)

(21) Appl. No.: 14/643,046

(22) Filed: Mar. 10, 2015

(30) Foreign Application Priority Data
Mar. 11, 2014 (KR) 10-2014-0028241

(51) Int. Cl. G06F 12/08

(52) U.S. Cl. CPC G06F 12/0891; G06F 2212/621

(57) ABSTRACT

Disclosed are a method and apparatus for controlling a cache memory in an electronic device. The apparatus includes a cache memory having cache lines, each of which includes tag information and at least two sub-lines. Each of the at least two sub-lines including a valid bit and a dirty bit. A control unit may analyze a valid bit of a sub-line corresponding to an address tag of data when a request for writing the data is sensed, determine based on activation or deactivation of the valid bit whether a cache hit or a cache miss occurs, and perform a control operation for allocating a sub-line according to a size of the requested data and write the data when the cache hit occurs.

### CLAIM OF PRIORITY

This application claims priority from and the benefit under 35 U.S.C. §119(a) of Korean Patent Application No. 10-2014-0028241, filed on Mar. 11, 2014, which is hereby incorporated by reference in its entirety for all purposes as if fully set forth herein.

### BACKGROUND

1. Technical Field

The present disclosure relates generally to cache memory and cache memory control in an electronic device.

2. Description of the Related Art

A cache memory refers to a high-speed memory that temporarily stores information between a processor having a relatively high processing speed and a main memory having a relatively low access speed. When a write operation into a cache memory is requested, an electronic device determines whether cache lines (also known as “cache blocks”) of the cache memory are capable of being used. When the cache lines are so capable of being used, the electronic device can store data in the cache memory for each relevant cache line.

### SUMMARY

With conventional devices, however, when a write operation into a memory is requested, typically, there are many cases in which a request for writing data of smaller size than that allocated for a cache line is made. Specifically, in a write-back policy of a cache (a policy of writing data back from the cache to the main memory), in the case of a cache write, a request for writing data of smaller size than a line buffer size of a typical cache memory is frequently made. In this case, frequent access to the cache memory is problematic in that access service efficiency is reduced and latency increases.

An illustrative embodiment of the present disclosure provides a method and an apparatus which enable an electronic device to divide a line buffer of a cache memory into at least two sub-lines (“sub-line buffers”) and to access a relevant sub-line buffer according to the size of data for which access has been requested. Also, each sub-line buffer can have a valid bit and a dirty bit, and the method and the apparatus can perform a read operation and/or a write operation from and/or to only a relevant sub-line by analyzing the valid bit and/or the dirty bit during the data read operation and/or the data write operation.

In accordance with an aspect of the present disclosure, an apparatus of an electronic device includes a cache memory including multiple lines, each of which includes tag information and at least two sub-lines. Each of the at least two sub-lines includes a valid bit and a dirty bit. A control unit is configured to perform a control operation for writing requested data to a cache line, where the writing comprises allocating a number of sub-lines of the cache line according to a size of the data to be written, writing the data to at least one sub-line allocated, and setting the valid and dirty bits associated with at least one sub-line to values that reflect the writing and whether the data is concurrently stored in a main memory

In accordance with another aspect of the present invention, a method for controlling a cache memory in an electronic device is provided. The method includes determining a value of a valid bit of each of plural sub-lines of a cache line corresponding to tag information of the data when a request for writing the data is made; determining based on the value of the valid bit whether a cache hit or a cache miss occurs; allocating a sub-line according to a size of the requested data and writing the data, when the cache hit occurs.

In accordance with another aspect, a method performed by an electronic device having a cache memory comprises processing a request for reading or writing data from a cache line of the cache memory associated with a tag address; determining values of respective valid bits associated with respective sub-lines of the cache line; and based on the values and the size of the data, performing the reading or writing of the data from or to selected sub-lines of the cache line.

An electronic device according to various embodiments of the present disclosure can provide multiple divided sub-lines to one cache line and thereby can use only a relevant sub-line during a write operation for data of a smaller size than the size of a cache line. Accordingly, the electronic device according to various embodiments can increase write service efficiency and can reduce latency.

### BRIEF DESCRIPTION OF THE DRAWINGS

The above and other aspects, features and advantages of the presently disclosed technology will be more apparent from the following detailed description in conjunction with the accompanying drawings, in which:

FIG. 1 is a block diagram illustrating a configuration of an electronic device according to an example;

FIG. 2 is a view illustrating a configuration of a cache memory according to an example;

FIG. 3 is a flowchart illustrating a method for controlling a cache memory according to an example;

FIG. 4 is a flowchart illustrating a method for performing a read operation from a cache memory according to an example;

FIG. 5 is a flowchart illustrating a method for performing a write operation to a cache memory according to an example;

FIG. 6A illustrates a cache line and data states thereof for explaining a method of reading from cache memory according to an example;

FIG. 6B illustrates a cache line and data states thereof for explaining a method for writing to cache memory when a cache hit occurs, according to an example; and

FIG. 6C illustrates a cache line and data states thereof for explaining a method for writing to cache memory when a cache miss occurs, according to an example.

### DETAILED DESCRIPTION

Hereinafter, various embodiments of the present technology will be described with reference to the accompanying drawings. It should be noted that the same elements will be designated by the same reference numerals although they are shown in different drawings. Further, a detailed description of a known function and configuration which may obfuscate the subject matter of the present technology will be omitted. Hereinafter, it should be noted that only the descriptions will be provided that may help understanding the operations provided in association with the various embodiments of the present invention, and other descriptions may be omitted for conciseness of explanation.

Meanwhile, illustrative embodiments shown and described in this specification and the drawings correspond to specific examples presented in order to easily explain technical contents of the present technology, and to help comprehension of the present technology, but are not intended to limit the scope of the present invention as defined by the appended claims. It will be apparent to those having ordinary knowledge in the technical field, to which the present disclosure pertains, that it is possible to practice other modified embodiments based on the technical idea of the present disclosure as well as the embodiments disclosed herein.

In the field of cache memory, the term “cache line”, which is often called a “cache block”, is a basic unit of cache storage. A cache line may contain multiple bytes of data. A “valid bit” is a bit associated with a cache block that indicates whether the cache block is used (has valid data) or not. A “dirty bit” (sometimes called a “modify bit”) is a bit that is associated with a cache block and indicates whether or not a modification (overwrite) of the block has been saved to storage (e.g. main memory such as disk storage). A “cache hit” is a state in which data requested for processing by a component or application is found in the cache memory. A “cache miss” is a state where the data requested for processing by a component or application is not found in the cache memory. A “tag” refers to a label for a cache entry indicating where it came from, such as a part of CPU address. The term “writing back” refers to writing data stored in a cache to the storage.

In an electronic device according to various embodiments of the present disclosure, a cache memory may be configured to maintain a tag of a line, divide the line into at least two sub-lines, and assign a valid bit and a dirty bit to each sub-line, when the line is configured. Accordingly, one line of the cache memory may include one tag and multiple sub-lines, and each of the multiple sub-lines may include a valid bit and a dirty bit.

In the cache memory having the above-described structure, in the case of a cache hit, only a relevant part of the data stored within the entire cache line may be written back to the main memory. That is, the subsequent write-back is made in such a manner that a write operation is not performed by an entire line size but is performed by only the requested size. In addition, a valid bit and a dirty bit are set for an individual sub-line rather than for the entire cache line. In the case of a cache miss, with a conventional device, when a read operation is performed by the entire line size (e.g., 64 bytes) and the requested data needs to be written from the main memory to the cache line, if data has a smaller size than the line size, the read operation needs to be performed by the entire line size and the write operation needs to be performed. As a result, excessive processing is required in the conventional read operation in this scenario. With the presently disclosed embodiments, however, a read operation is not performed by the entire line size in this condition. Instead, only a relevant sub-line may be immediately written back by dividing the line size of the cache memory into multiple sub-line sizes and assigning a valid bit and a dirty bit to each sub-line.

Herein, an electronic apparatus 100 according to the present disclosure may be a mobile communication terminal, a smartphone, a tablet Personal Computer (PC), a hand-held PC, a Portable Multimedia Player (PMP), a Personal Digital Assistant (PDA), a notebook PC or the like.

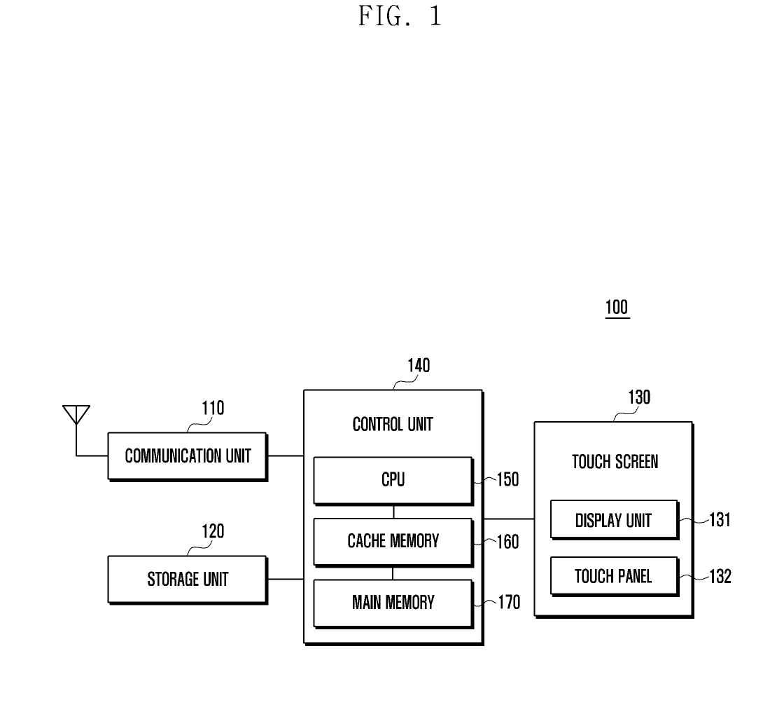

FIG. 1 is a block diagram illustrating a configuration of an electronic device, 100, according to an embodiment of the present invention. Electronic device 100 may include a communication unit 110, a storage unit 120, a touch screen 130, and a control unit 140.

The communication unit 110 performs a voice call, a video call, or data communication between the electronic device and an external device through a network. The communication unit 110 may include a Radio Frequency (RF) transmitter for upconverting a frequency of a signal to be transmitted and amplifying the frequency-upconverted signal, an RF receiver for low-noise amplifying a received signal and downconverting a frequency of the low-noise amplified signal, and the like. Also, the communication unit 110 may include a modulator-demodulator (modem). Examples of the modem include a Code Division Multiple Access (CDMA) modem, a Wideband Code Division Multiple Access (WCDMA) modem, a Long Term Evolution (LTE) modem, a Wi-Fi modem, a Wireless Broadband Internet (WiBro) modem, a Bluetooth modem, a Near Field Communication (NFC) modem, and the like. The communication unit 110 may be a mobile communication module, an Internet communication module, and/or a short-range communication module.

The storage unit 120 may include a program memory for storing an operating program of the electronic device, and a data memory for storing data generated during execution of a program.

The touch screen 130 may be implemented as an integral-type touch screen including a display unit 131 and a touch panel 132. Under the control of the control unit 140, the display unit 131 may display various screens according to the use of the electronic device. The display unit 131 may be implemented by a Liquid Crystal Display (LCD), an Organic Light Emitting Diode (OLED) display, and/or an Active Matrix Organic Light Emitting Diode (AMOLED) display. The touch panel 132 may be an integrated touch panel including a hand touch panel for sensing a hand gesture and a pen touch panel for sensing a pen gesture.

The control unit 140 controls an overall operation of the electronic device and a signal flow between internal elements of the electronic device, processes data, and controls the supply of power from a battery to the elements. Also, the control unit 140 may include a cache memory 160 for temporarily storing data to be recorded in a Central Processing Unit (CPU) 150 and the storage unit 120 and for temporarily storing data read from the storage unit 120, and a main memory 170. In an embodiment of the present invention, the cache memory 160 may include multiple cache lines having address tag information indicating a storage location of data, each of the multiple cache lines may be divided into at least two sub-lines, and each sub-line may include a valid bit and a dirty bit.

Particularly, in an embodiment of the present invention, when a data read is requested, the control unit 140 may read a cache line of the cache memory 160 corresponding to an address tag of data. The cache line has at least two sub-lines, and the control unit 140 may analyze a valid bit of each of the sub-lines of the read cache line, may read a sub-line having an activated valid bit detected through the analysis of the valid bit, and may determine whether a cache hit or a cache miss has occurred. When the cache hit has occurred, the control unit 140 may read data from the relevant sub-line. In contrast, when the cache miss has occurred, the control unit 140 may read data from the main memory 170.

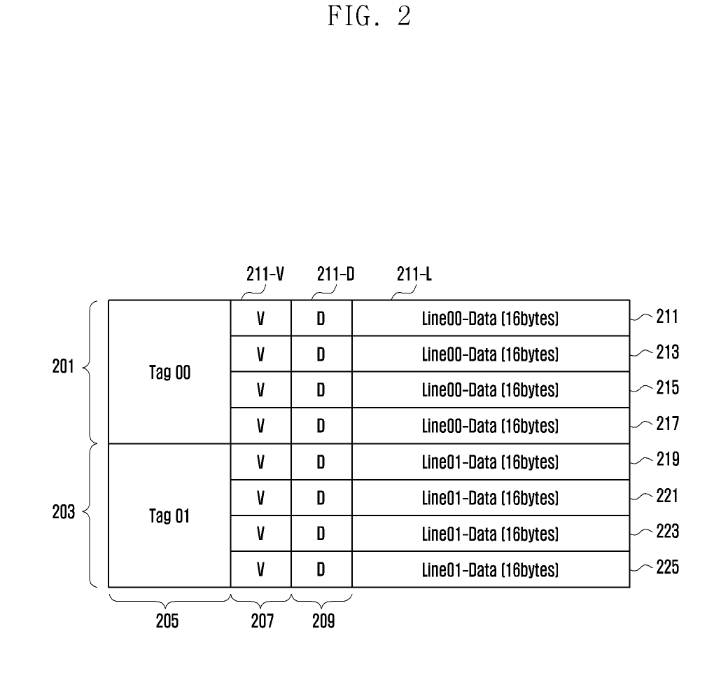

In addition, the electronic device may selectively further include elements having additional functions, such as a Global Positioning System (GPS) module for receiving location information, a camera module for capturing a still image and a moving image, an audio processing unit including a microphone and a speaker, a broadcast receiving module for receiving a broadcast signal, an input unit for supporting hard key-based input, and the like. FIG. 2 is a view illustrating a configuration of cache memory lines according to an example. The cache memory 160 of FIG. 1 includes multiple cache lines such as 201, 203 each having an address tag information part 205 representing a cache line 201, 203 (which are storage locations of data). Also, each of the cache lines may include at least two divided sub-lines, where each has a valid bit “V” and a dirty bit “D”. For example, a first cache line 201 is comprised of a tag 205 (Tag 00) and the sub-lines 211, 213, 215 and 217, where each sub-line includes a storage location V (also called “valid bit V”) for indicating a valid bit, and a storage location D (also called “dirty bit D”) for indicating a dirty bit. For instance, the sub-line 211 may be considered composed of a storage location 211-L for data, a storage location 211-V for storing a valid bit, and a storage location 211-D for storing a dirty bit. Likewise, in this example a second cache line 203 is comprised of the sub-lines 219, 221, 223 and 225 a tag 205 (Tag 01), four valid bits and four dirty bits. Regions 207 and 209 denote general storage regions for valid bits and dirty bits, respectively.

Here, the valid bit V indicates whether data corresponding to the address tag is valid, and the associated sub-line may be read through the activation or deactivation of the valid bit V. Further, the dirty bit D indicates whether a write operation of writing data existing in the cache memory 160 to the main memory 170 has been performed. The dirty bit D may be activated during a write operation to the cache memory 160. The activation of the dirty bit D (i.e., a dirty bit value is set to 1) may represent a state in which data is stored only in the cache memory 160 and not in the main memory 170. Thereafter, a write operation (i.e., write-back) of writing the data stored in the cache memory 160 to the main memory 170 may be performed. After the write operation is performed, the dirty bit 209 may be changed to an initialization state (i.e., a dirty bit value is set to 0). A cache line having Tag00 representing tag information indicated by reference numeral 201 may include four divided sub-lines 211, 213, 215 and 217. Also, a cache line having Tag01 representing an address tag indicated by reference numeral 203 may include four divided sub-lines 219, 221, 223 and 225. During a data write operation to the cache memory 160 having the above-described configuration, a sub-line may be allocated for the size of the data, and the data write operation to the allocated sub-line may be performed.

For example, a case is considered in which the size of the cache line having the tag information Tag00 is equal to 64 bytes and the cache line is divided into four sub-lines and thereby each of the four sub-lines has a size of 16 bytes. When a write operation for data having a size of 10 bytes is performed, one sub-line of 16 bytes may be allocated for the data size of 10 bytes. The remaining three sub-lines except for this one sub-line, to which the write operation has been performed among the four sub-lines, may be used during a next data write operation. As another example, when a write operation for data having a size of 20 bytes is performed, two sub-lines may be allocated for the data size of 20 bytes.

Hereinafter, in embodiments described below, a case will be described in which, as described above, a 64-byte cache line having address tag information is divided into four sub-lines and a read and/or write operation from and/or to the sub-lines is performed. However, the present invention is not limited thereto, so that cache lines using more or fewer bytes and divided in portions other than four are likewise possible.

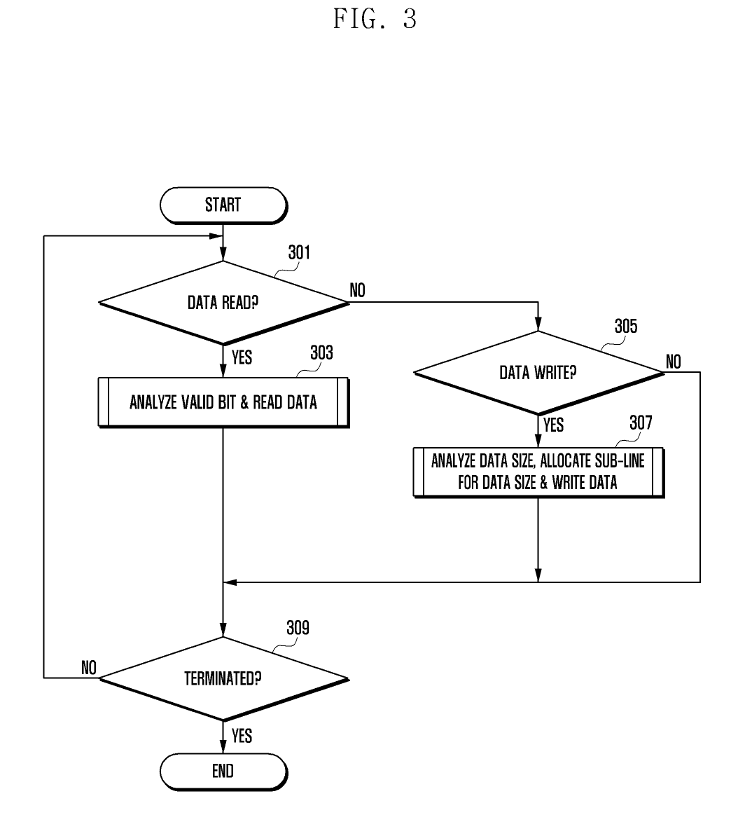

FIG. 3 is a flowchart illustrating a method for controlling a cache memory according to an example. With this method, the control unit 140 may first determine whether a request for reading data is made (operation 301). At this time, the data may include address tag information indicating a storage location. When the request for reading data is made, in operation 303, the control unit 140 may then read a cache line corresponding to the address tag, analyze a valid bit of each of multiple sub-lines included in the cache line, extract a sub-line having an activated valid bit through the analysis, and perform a read operation of data from the extracted sub-line.

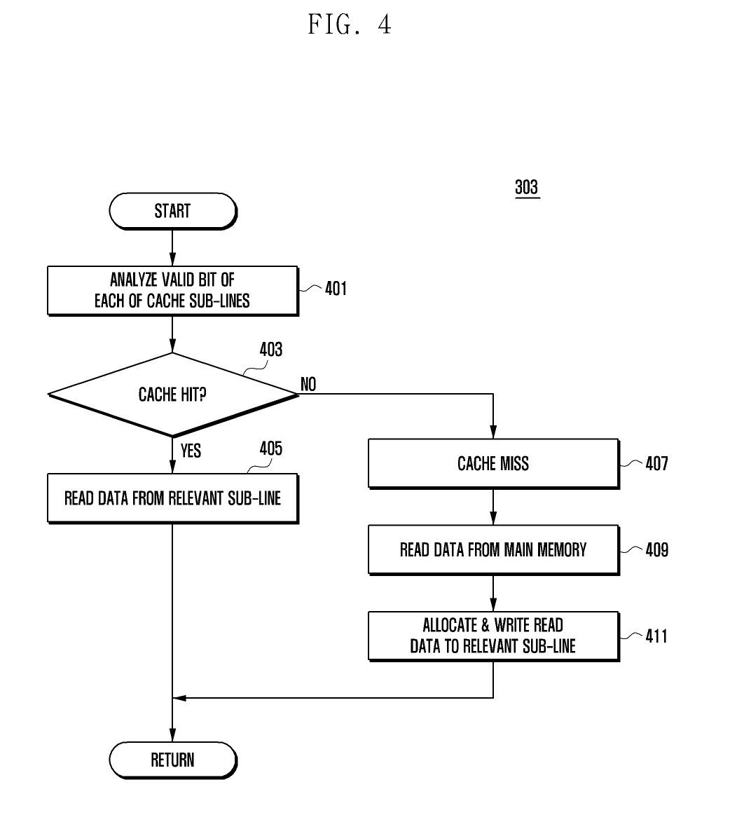

Detailed execution steps of operation 303 illustrated in FIG. 3 will be described in detail with reference to FIG. 4.

FIG. 4 is a flowchart illustrating a method for performing a read operation from a cache memory according to an example. Here, in operation 401, the control unit 140 may analyze a valid bit of each of the sub-lines of a cache line. Subsequently, as a result of the analysis, access to only a sub-line(s) having an activated valid bit may be performed, so that a data read is only performed on the relevant sub-line. Specifically, after reading a relevant cache line in response to a data read request, when a sub-line has a valid bit of 1 among sub-lines of the cache line, the control unit 140 may determine that data is valid (i.e., a case where data is stored in the sub-line) and may read only the sub-line having a valid bit of 1. In other words, when the data read request has been made, the control unit 140 reads only the sub-line having a valid bit of 1 through the analysis of the valid bit, and thereby can reduce an execution time period of a read operation.

Next, the control unit 140 may determine, from the cache memory 160, whether a cache hit or a cache miss occurs in order to determine whether the data, for which reading has been requested, is located in a sub-line. Here, the cache hit may occur when the data, of which reading has been requested, is located in the cache memory 160. In contrast, the cache miss may occur when the data, for which reading has been requested, is not located in the cache memory 160 (but is instead likely located in the main memory).

In operation 403, the control unit 140 may determine whether the cache hit occurs. When the cache hit occurs, in operation 405, the control unit 140 may read data stored in a relevant sub-line area.

In contrast, when it is determined in operation 403 that the cache hit does not occur, in operation 407, the control unit 140 may recognize that the cache miss occurs, and may read the data, for which reading has been requested, from the main memory 170 in operation 409. In operation 411, the control unit 140 may perform a write operation of writing the data, which has been read from the main memory 170, to the cache memory 160. When the write operation is performed, the control unit 140 may allocate a sub-line for the size of the requested data and may perform the write operation.

Returning back to the description of FIG. 3, when the request for reading the data is not made in operation 301, in operation 305, the control unit 140 may determine whether a request for writing data is made. If so, in operation 307 the control unit 140 may analyze the size of the data and address tag information of an address at which the data, for which writing has been requested, is to be stored. Then, the control unit 140 may allocate a sub-line for the size of the data on the basis of a result of the analysis, and may perform a write operation.

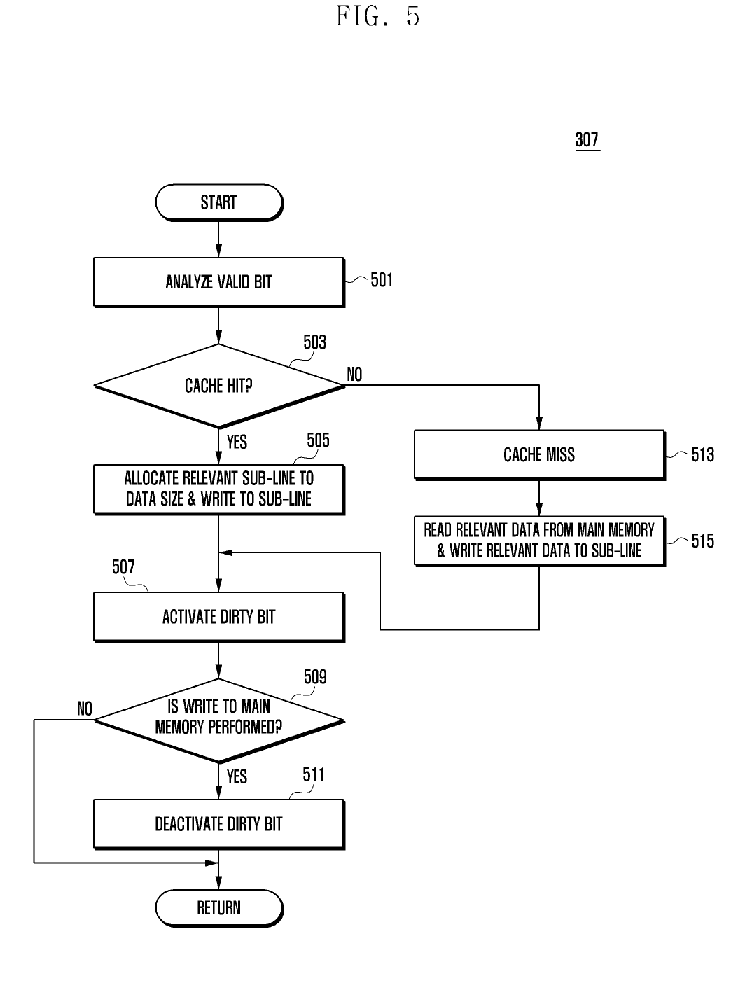

Detailed illustrative execution steps of operation 307 illustrated in FIG. 3 will be described in detail with reference to FIG. 5.

FIG. 5 is a flowchart illustrating a method for performing a write operation to a cache memory according to an example. To carry out an instruction to write data, the control unit 140 may first analyze a valid bit of each of the sub-lines of a cache line (operation 501). Next, the control unit 140 may determine whether a cache hit occurs, based on a result of the analysis (operation 503). When a valid bit of each of the sub-lines of the cache line is equal to 1, the control unit 140 may determine that data is valid and may determine that the cache hit occurs. When it is determined that the cache hit occurs, in operation 505, the control unit 140 may allocate a sub-line corresponding to the tag information for the size of the data, and may perform a data write operation to the allocated sub-line. After the write operation is performed, in operation 507, the control unit 140 may activate a dirty bit (i.e., a dirty bit value is set to 1). According to the activation or deactivation of the dirty bit, the control unit 140 may determine whether a write operation to the main memory 170 is to be performed. Specifically, if the dirty bit is equal to 1, it implies that data stored in the cache memory 160 does not exist in the main memory 170. At this time, the control unit 140 may perform a write operation of writing the data to the main memory 170, and thereby may store the data in the main memory 170. In operation 509, the control unit 140 may determine whether a data write operation to the main memory 170 is performed. When it is determined that the data write operation to the main memory 170 is performed, the control unit 140 may sense in operation 509 that the data write operation to the main memory 170 is performed, and may deactivate the dirty bit (i.e., the dirty bit value is set to 0) in operation 511. That is, the deactivation of the dirty bit implies that the data, of which writing has been requested, is stored in the main memory 170. At this time, the dirty bit value may be changed from 1 to 0.

In contrast, when it is determined in operation 503 that the cache hit does not occur, in operation 513, the control unit 140 may recognize that a cache miss occurs, and the flow proceeds to 515. Here, the control unit 140 may read data from the main memory 170, may allocate a relevant sub-line for the size of the data, and may perform a write operation of writing the data to the allocated sub-line. In operation 507, the control unit 140 may activate a dirty bit (i.e., a dirty bit value is set to 1). In operation 509, the control unit 140 may determine whether a data write operation to the main memory 170 is performed. When it is determined that the data write operation to the main memory 170 is performed, the control unit 140 may sense in operation 509 that the data write operation to the main memory 170 is performed, and may deactivate the dirty bit (i.e., the dirty bit value is set to 0) in operation 511.

Returning to FIG. 3, in operation 309, the control unit 140 may determine whether a termination command is generated. When the termination command is generated, in operation 309, the control unit 140 may sense the generation of the termination command, and may terminate the data read and/or write operation. In contrast, when the termination command is not generated, the control unit 140 may branch back to operation 301.

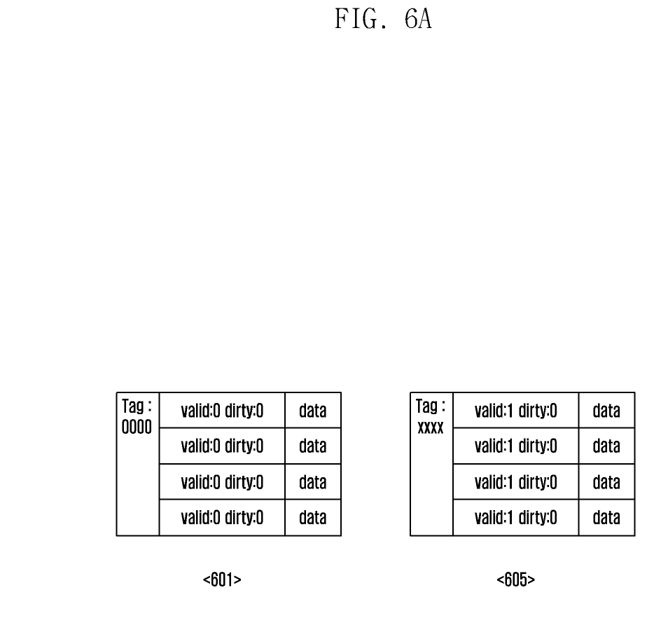

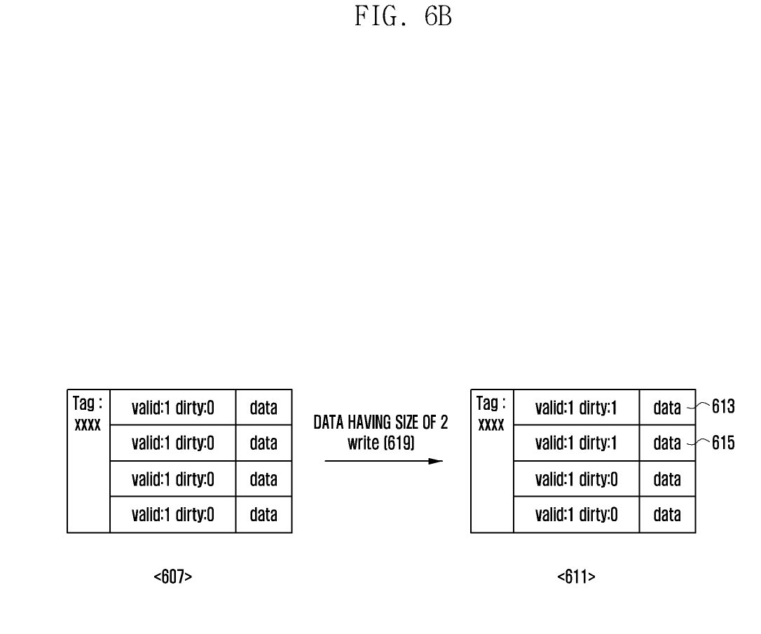

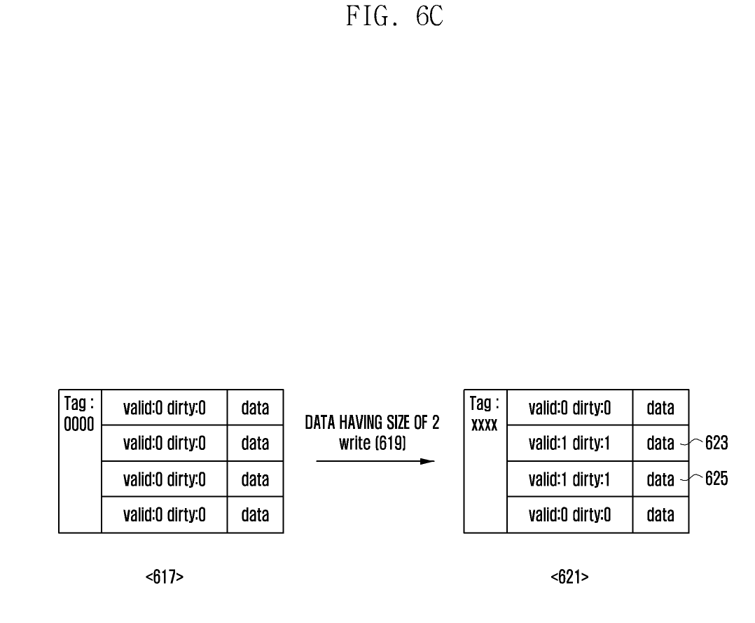

FIGS. 6A to 6C are views representing respective cache lines and data states for explaining an overall method for controlling a cache memory according to an example. FIG. 6A illustrates a cache line and data states thereof for explaining a method for reading the cache memory 160. A case will be described in which one read attempt is made from a cache line 601 having an address tag 0000. Another example is given of a read attempt made from a cache line 605 having an address tag xxxx. Each cache line is exemplified in a state of a cache line having four sub-lines. For example in cache line 601, each sub-line has the same address tag 0000, a valid bit equal to 0, and a dirty bit equal to 0. The control unit 140 may sense an operation of reading the cache line 601 having the address tag in a state where the address tag is equal to 0000. However, since the valid bits in each of the sub-lines of cache line 601 have a value of 0, a cache miss occurs on this read attempt, thus a read would next be attempted from a corresponding address of the main memory.

When a request for reading the cache line 605 having the address tag xxxx is made, the control unit 140 may attempt to read the cache line 605. Since four sub-lines of the cache line 605 having the address tag xxxx all have a valid bit equal to 1, all sub-lines are in a state of having valid data, whereby the read attempt results in a cache hit.

FIG. 6B is a view illustrating a cache line and data states thereof for explaining a method for performing a data write operation when a cache hit occurs. A case will be described in which a write operation is performed for writing data having a “size of 2” (i.e., enough data to fit within just two sub-lines) to a cache line 607 having four sub-lines, where each sub-line has an address tag xxxx, a valid bit equal to 1, and a dirty bit equal to 0 as shown in cache line 607. Prior to the write request, the cache line 607 is in a state of having a valid bit equal to 1, and is considered in a state of a cache hit since each dirty bit is 0 and thus the data is already duplicated in the main memory.

A request may be made for a write operation of writing data having a size of 2 to the cache line 607 having the address tag xxxx as indicated by reference numeral 609. Since the data write operation has been requested in the state of the cache hit, the control unit 140 may allocate sub-lines (e.g., two sub-lines) for the data size of 2 and may perform the write operation, resulting in a state indicated by cache line 611 (where cache line 611 is the same as cache line 607 but with the values of two of the dirty bits changed). After the write operation is performed, the control unit 140 may change the value of the dirty bit of each of the two allocated sub-lines to 1, as indicated by reference numerals 613 and 615. The change of the dirty bit value to 1 implies that new data is stored in the cache memory 160, and signifies a state in which a write operation of writing the new data to the main memory 170 has not yet been performed. When the write operation of writing the new data to the main memory 170 is performed, the dirty bit value may be changed back from 1 to 0. That is, the latter state (dirty bits=0) may be a state of maintaining consistency between the cache memory 160 and the main memory 170.

FIG. 6C is a view illustrating a cache line and data states thereof for explaining a method for performing a data read and write operation when a cache miss occurs. That is, when a read attempt is made from a particular address of the cache, if it is determined that no data is currently stored in the cache line of that cache address, this represents a cache miss, so the data is then retrieved from the main memory and also written to the cache line. The control unit 140 may sense a request for reading data in a state of the cache memory 160 which has a cache line address tag 0000, a valid bit equal to 0, and a dirty bit equal to 0 as indicated by reference numeral 617 in FIG. 6C. When sensing the request for reading the data, the control unit 140 may analyze the valid bit. As described above, the valid bit equal to 0 represents a state where the data, of which reading has been requested, is not stored in the cache memory 160. At this time, since the data, of which reading has been requested, is not stored in the cache memory 160, the control unit 140 may determine that the cache miss occurs. When the cache miss has occurred, the control unit 140 may read the data from the main memory 170. Then, the data read from the main memory 170 may be copied from the main memory to the cache line, at a relevant sub-line as indicated by cache line 619, according to the size of the data, and then a write operation for the data may be performed. The control unit 140 may perform the write operation of writing the data to the cache memory 160, and thereby may set both values of the valid bit and the dirty bit of each of the relevant sub-lines to 1, as indicated by reference numerals 621, and 623 and 625.

In various embodiments, the above-described methods according to the present disclosure may be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered using such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. No claim element herein is to be construed under the provisions of 35 U.S.C. 112, sixth paragraph, unless the element is expressly recited using the phrase “means for.”

Although methods and apparatus for controlling cache memory in electronic device has been described above in connection with the embodiments disclosed in the present specification and drawings, these embodiments are provided merely to readily describe and to facilitate an understanding of the present invention, and are not intended to limit the scope of the present invention. Therefore, it should be construed that all modifications or modified forms derived from the technical idea of the present invention in addition to the embodiments disclosed herein are included within the scope of the present invention as defined by the appended claims.

What is claimed is:

1. An apparatus comprising:
a cache memory including multiple cache lines, each of which includes tag information and at least two sub-lines, each of the at least two sub-lines including a valid bit and a dirty bit associated therewith; and
a control unit configured to perform a control operation for writing requested data to a cache line, the writing comprising allocating a number of sub-lines of the cache line according to a size of the data to be written, writing the data to at least one sub-line allocated, and setting the valid and dirty bits associated with the at least one sub-line to values that reflect the writing and whether the data is concurrently stored in a main memory.

2. The apparatus of claim 1, wherein the control unit is further configured to:
analyze a valid bit of a sub-line corresponding to an address tag of data when a request for writing the data is sensed;
determine based on activation or deactivation of the valid bit whether a cache hit or a cache miss occurs;
perform a control operation for allocating a sub-line according to a size of the requested data and writing the data when the cache hit occurs; and
perform a control operation for activating the dirty bit of the sub-line and writing the data of the sub-line having the activated dirty bit to the main memory, and deactivating the dirty bit after writing the data.

3. The apparatus of claim 2, wherein the control unit reads the data from the main memory and writes the data to the at least one sub-line, when the cache miss occurs.

4. The apparatus of claim 3, wherein the control unit senses that the cache hit occurs when the valid bit is activated which indicates whether data is valid, and senses that the cache miss occurs when the valid bit is deactivated.

5. The apparatus of claim 1, wherein the control unit analyzes the valid bit of each of the sub-lines when a request for reading data is sensed, determines based on activation or deactivation of the valid bit whether a cache hit or a cache miss occurs, and performs a control operation for reading the data of the at least one sub-line when the cache hit occurs.

6. The apparatus of claim 5, wherein the control unit performs a control operation for reading the data from a main memory and performs a control operation for writing the read data to the cache memory, when the cache miss occurs.

7. A method for controlling a cache memory in an electronic device, the method comprising:
determining a value of a valid bit of each of plural sub-lines of a cache line corresponding to tag information of data when a request for writing the data is made;
determining based on the value of the valid bit whether a cache hit or a cache miss occurs; and
allocating a sub-line according to a size of the data to be written and writing the data, when the cache hit occurs.

8. The method of claim 7, further comprises:
activating a dirty bit of the sub-line; and
writing the data of the sub-line having the activated dirty bit to a main memory.

9. The method of claim 8, further comprises:
deactivating the dirty bit when the data is written to the main memory.

10. The method of claim 7, further comprising:
reading the data from a main memory and writing the data read from the main memory to the relevant sub-line, when the cache miss occurs.

11. The method of claim 10, wherein the valid bit indicates whether data is valid, the cache hit is determined when the valid bit is activated, and the cache miss is determined when the valid bit is deactivated.

12. The method of claim 7, further comprising:
analyzing a valid bit of each of sub-lines when a request for reading data is sensed;
determining based on activation or deactivation of the valid bit whether a cache hit or a cache miss occurs; and
reading the data from the relevant sub-line when the cache hit Occurs.

13. The method of claim 12, further comprising:
when the cache miss occurs, reading the data from a main memory; and
writing the read data to the sub-line.

14. The method of claim 7, wherein the cache line contains exactly four sub-lines.

15. The method of claim 14, wherein each sub-line is allocated for storing exactly 16 bytes of data.

16. A method performed by an electronic device having a cache memory, the method comprising:
processing a request for reading or writing data from a cache line of the cache memory associated with a tag address;
determining values of respective valid bits associated with respective sub-lines of the cache line; and
based on the values and a size of the data, performing the reading or writing of the data from or to selected sub-lines of the cache line.
